(19) United States
(12) Patent Application Publication
(10) Pub. No.: US 2005/0154484 A1
(43) Pub. Date: Jul. 14, 2005

(54) Photolithographic parameter feedback system and control method thereof

(75) Inventors: Yung-Yao Lee, Yongkang City (TW); Tseng-Yung Wang, Chiayi City (TW)

Correspondence Address: BIRCH STEWART KOLASCH & BIRCH, PO BOX 747, FALLS CHURCH, VA, 22040-0747, US

(73) Assignee: ProMOS Technologies Inc., Hsinchu (TW)

(21) Appl. No.: 10/949,361

(22) Filed: Sep. 27, 2004

(30) Foreign Application Priority Data
Dec. 25, 2003 (TW) 092136813

(51) Int. Cl. G06F 19/00

(52) U.S. Cl. 700/121; 700/108; 716/21

(57) ABSTRACT

A photolithographic parameter feedback system is described. The photolithographic parameter feedback system includes a database containing substrate history information of a lot having at least one measurement data after exposure of a pre-layer of substrates of a predetermined lot and an exposure tool history information having at least one measurement data after exposure of a predetermined layer of substrates of a pre-lot, and an exposure tool exposing the substrates of the predetermined lot, wherein at least one exposure parameter thereof is updated by feedback of the substrate history information of the lot and the exposure tool history information.

### BACKGROUND

The invention relates to a parameter feedback system, and more specifically to a photolithographic parameter feedback system.

Recently, as integration density of integrated circuits has increased, semiconductor fabrication design has been developed to reduce element sizes. Thus, overlay quality between layers is of great importance due to the reduction of critical dimensions (CD).

Generally, exposure tools comprise steppers or scanners substantially constituted by a main system comprising an illustration system and a wafer stage system, and a control system. The illustration system further comprises a reticle stage, a series of lenses, an alignment system, and a light source generator.

A scanner alignment system is illustrated in FIG. 1. Description of the alignment mechanism follows. First, a reticle 10 is loaded on the reticle stage system of the scanner, and precisely positioned by calibrating with the position of the wafer stage system. A wafer 20 coated with photoresist is then loaded on the wafer stage system for execution of pre-exposure alignment. Next, an aligning light, such as He-Ne laser, is generated by an alignment light source system 40, and projected on the alignment mark 30 of the wafer 20 through a lens system 50. The reflective light signal 60, such as a diffractive light, then returns through the lens system 50, as well as a filter 70, and is finally collected by a detector 80.

Before exposure, precise alignment is performed by an alignment system to determine preferable compensative values for alignment parameters of a predetermined layer or the current layer. In conventional fabrication, overlay offset values between the current layer and its pre-layer are measured by an overlay measuring tool using an exposed test wafer, and thereby compensate alignment parameters to ensure the accurate alignment therebetween during exposure of the whole lot or several lots. Additionally, the test wafer is used to determine the sufficient exposure energy to precisely control critical dimension of pattern.

The test wafer, however, must be reworked with acid solution to remove photoresist after each test procedure. This may increase process cost due to excessive consumption of acid solution, and reduce utility rate of the exposure tool, thus decreasing yields.

A horizontal photolithographic parameter feedback system has been developed to solve the aforementioned problems. As shown in FIG. 2A, optimal alignment parameters are obtained by referring to historical statistics of the overlay measurement data of the current layer and several previous lots, such as three previous lots, stored in the photolithographic parameter feedback system database calculated by an automatic calculation model, through which exposure is then performed. This method provides stable overlay measurement for the current layer without test wafers. For example, when overlay offset values of a previous lot are produced, the current lot may decrease in compensating along the offset direction of the previous lot by the horizontal photolithographic parameter feedback system. FIG. 2B illustrates exposure results of the DT layer, wherein the X-axis represents different lot numbers, the right side of the Y-axis represents overlay measurement residual such as magnified overlay measurement residual (PPM) between the DT layer and its pre-layer, the left side of the Y-axis represents magnified overlay offset compensative values (PPCS) therebetween, and the baseline therein is −3.6 ppm. Residual defines a random factor which cannot be completely compensated by a linear compensation. In FIG. 2B, even the magnified overlay measurement residual shows four exceptional bumps A, B, C, and D corresponding to the four lots V6C04288, V6C04292, V6C04294, and V6C04296 respectively, the normal magnified overlay offset compensative values for each lot may still be obtained using the horizontal photolithographic parameter feedback system.

Referring to FIG. 2C, FIG. 2C illustrates exposure results of the GC layer aligned with the DT layer, wherein the X-axis represents different lot numbers, the right side of the Y-axis represents magnified overlay measurement residual (PPM) between the GC layer and the DT layer, the left side of the Y-axis represents magnified overlay offset compensative values (PPCS) therebetween. In FIG. 2C, the four exceptional bumps A′, B′, C′, and D′ are still shown therein. Thus, the overlay measurement residual of the pre-layer, such as the DT layer, may directly affect the residual of the current layer, such as the GC layer. Indeed, the overlay residual cannot be removed using the horizontal photolithographic parameter feedback system.

Alignment parameters of the current layer may be incorrectly compensated as the extraordinary residual of its pre-layer, resulting in faulty exposure parameters, causing serious overlay offsets in post layer fabrication. Other measurement data after exposure such as rotation offset compensative values may be confronted with the same problems. Thus, this system easily causes high rework rate with misalignment, significantly affecting fabrication schedule and increasing process cost.

### SUMMARY

In order to solve the conventional problems, embodiments of the invention provide a compensating method without use of test wafers and reworking for photoresist strip by acid solution.

Embodiments of the invention additionally provide a method for decreasing the rework rate caused by misalignment to improve fabrication schedule and reduce process cost.

Embodiments of the invention further provide a method for avoiding misalignment between the current layer and pre-layer thereof.

A method for controlling photolithographic parameters is provided. The method controls exposure parameters of the exposure tool by compensative values of a predetermined layer calculated from the substrate history information of the lot and the exposure tool history information with a calculation mode, then the substrates of the predetermined lot are exposed. First, substrate history information of a predetermined lot and exposure tool history information are provided. The substrate history information of the lot comprises at least one overlay measurement data after exposure of a pre-layer of the predetermined lot, and the exposure tool history information comprises at least one overlay measurement data after exposure of a predetermined layer of a pre-lot. Next, exposure parameters of the exposure tool are controlled by compensative values of the predetermined layer calculated by the substrate history information of the lot and the exposure tool history information with a calculation mode, then the substrates of the predetermined lot are exposed.

A photolithographic parameter feedback system comprising a database and an exposure tool is also provided. The database comprises substrate history information of a predetermined lot comprising at least one measurement data after exposure of a pre-layer of the predetermined lot, and an exposure tool history information comprising at least one measurement data after exposure of a predetermined layer of a pre-lot. The substrates of the predetermined lot are exposed by the exposure tool, wherein at least one exposure parameter of the tool is updated by feedback of the substrate history information of the lot and the exposure tool history information.

The aforesaid method and system consider not only the exposure tool history information (i.e. historical records of the current layer in the tool), but also the substrate history information (i.e. measurement data of a pre-layer for the substrate). Consequently, effect of the pre-layer on exposure performance of the current layer is diminished.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross section of a related exposure alignment system.

FIG. 2A is a flow chart of a related method for controlling photolithographic parameter feedback system.

FIGS. 2B˜2C show the residual of the pre-layer cannot be reduced by the related photolithographic parameter feedback system.

FIG. 3A illustrates the embodiment of the invention.

FIG. 3B shows the relationship among the overlay measurement data of the current layer, the overlay measurement residual after exposure of its pre-layer, and the baseline of the current layer of the exposure tool.

FIG. 3C illustrates the photolithographic parameter feedback system of the invention.

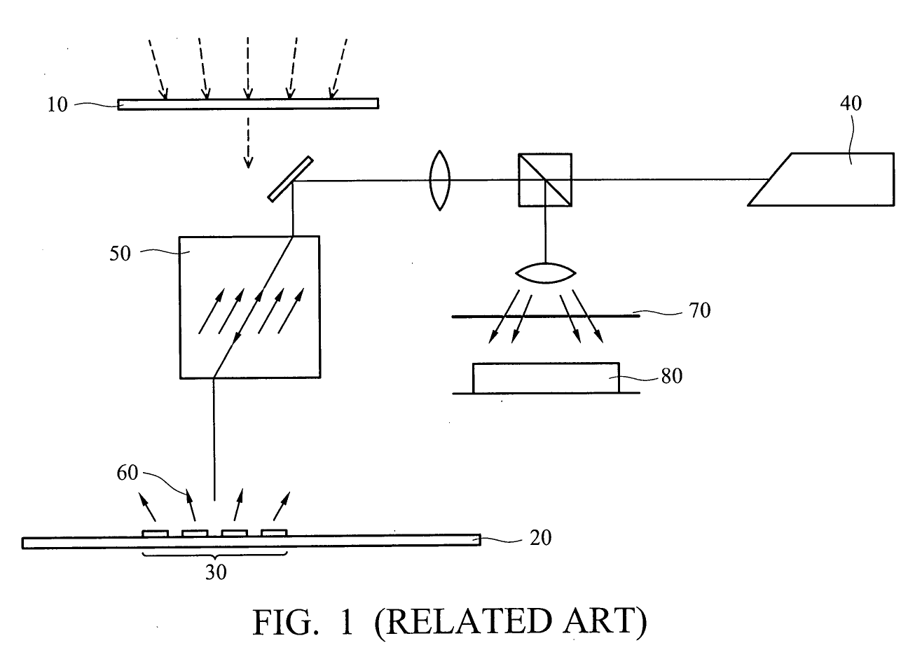

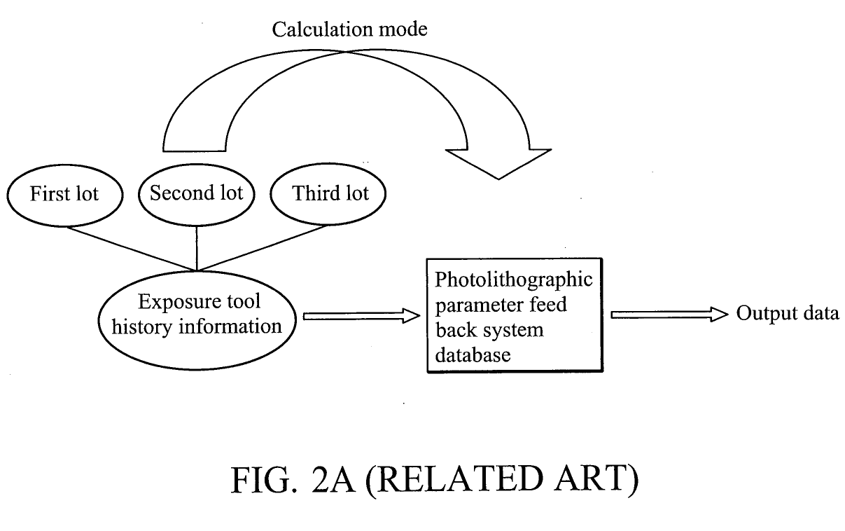

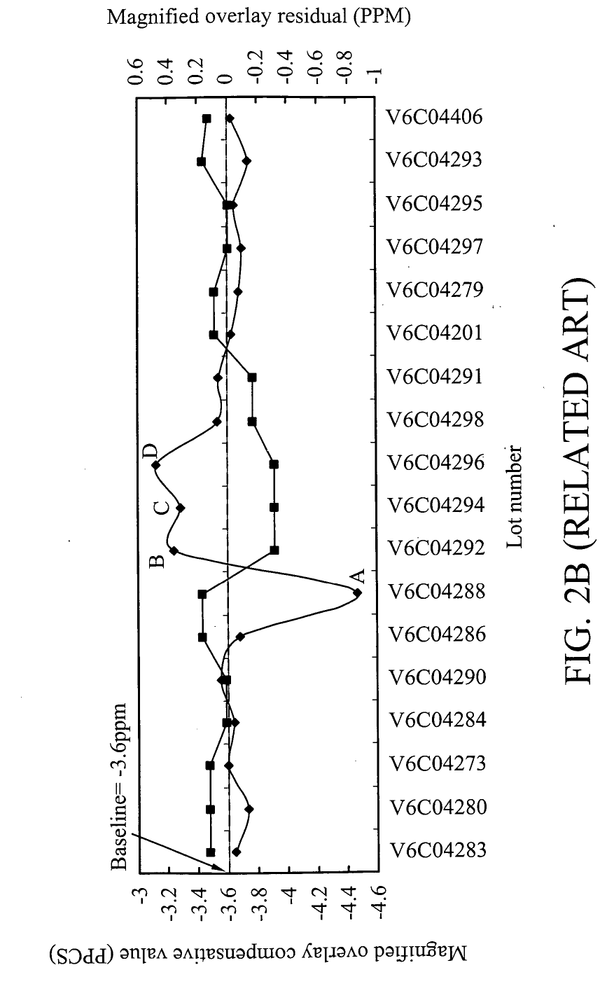

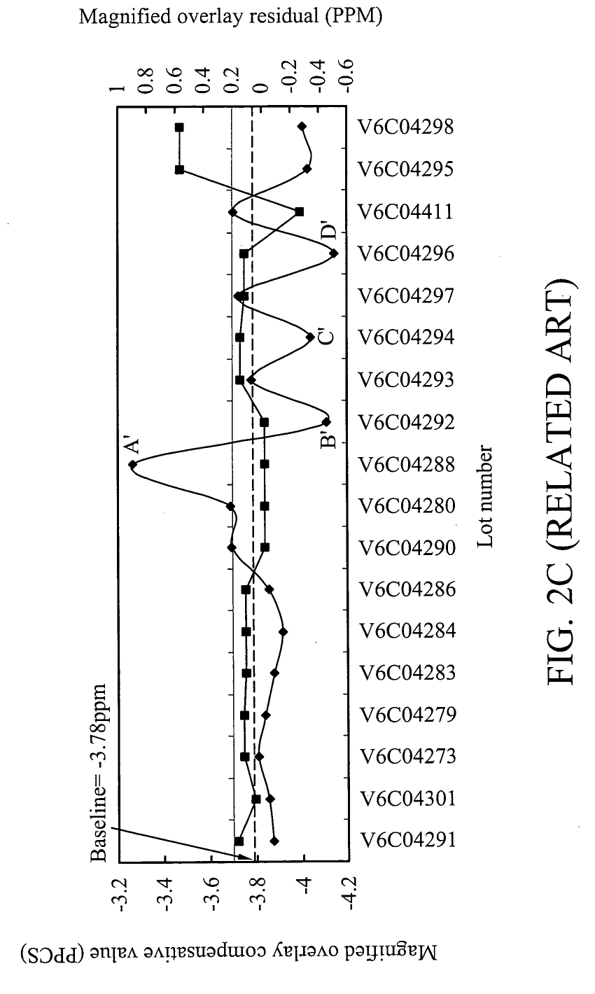

### DETAILED DESCRIPTION

When a specific layer of substrates of a lot is exposed, exposure parameters of the exposure tool are affected by measurement data after exposure of the current layer of substrates of several previous lots and measurement data after exposure of the pre-layer of substrates of the current lot. Put simply, the combination of the related horizontal photolithographic parameter feedback system (considering the measurement data of the current layer of pre-several lots) and a novel vertical photolithographic parameter feedback system (considering the measurement data of its pre-layer of the current lot) is provided. The substrate may be a wafer, a display substrate, an optical element substrate, a PCB, or other exposed materials.

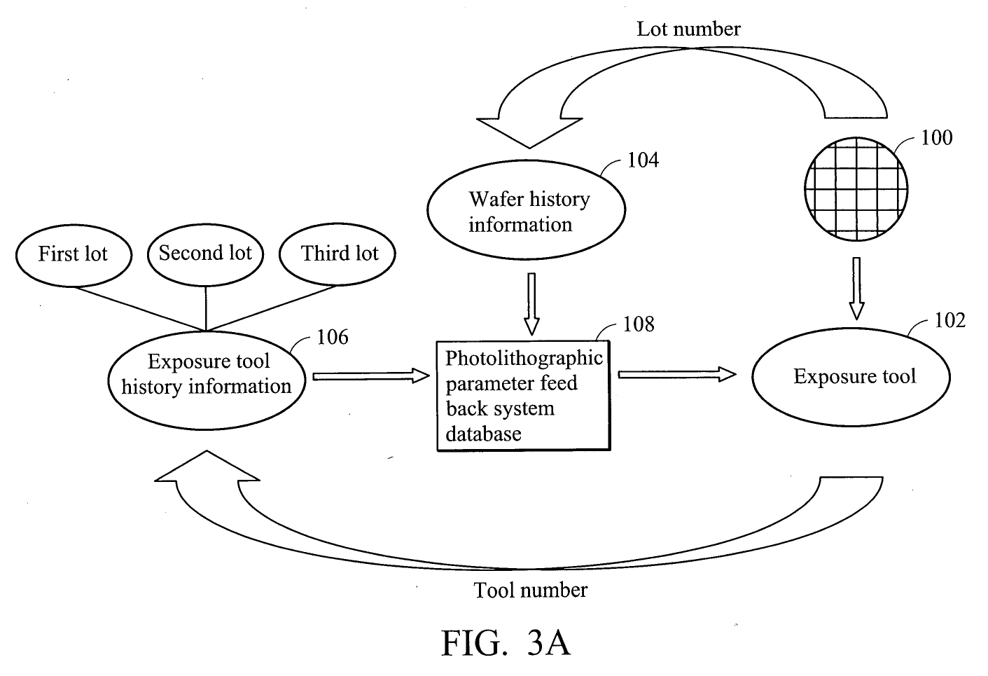

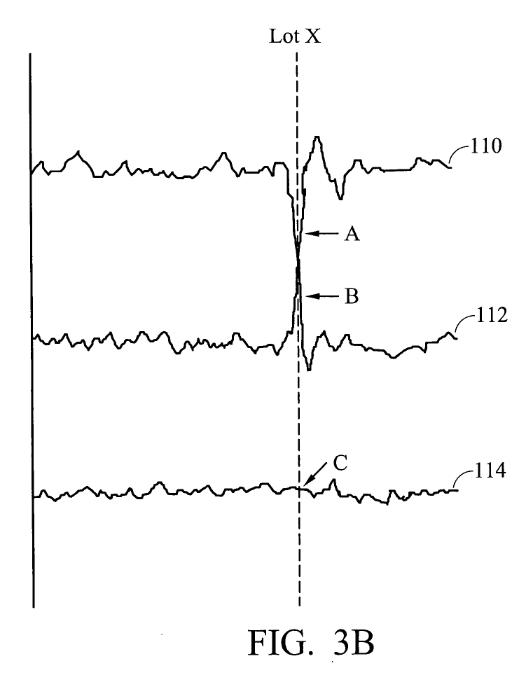

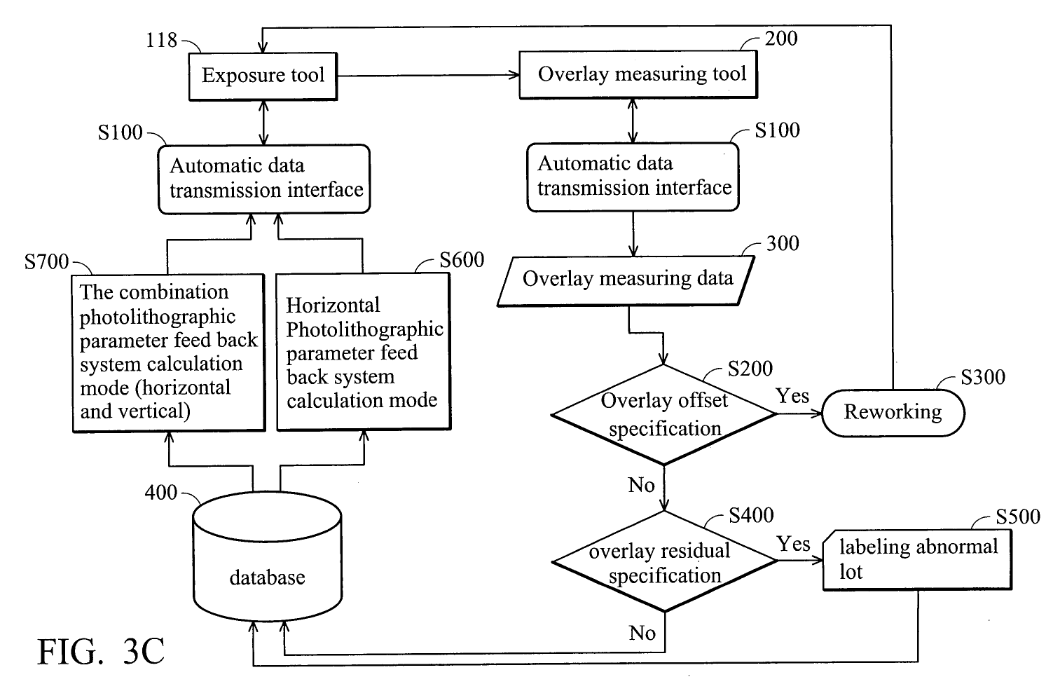

FIG. 3A illustrates the method for controlling photolithographic parameters with a semiconductor wafer fabrication. When wafers 100 of a lot are loaded into the exposure tool 102 to expose the M0 layer, the system of the invention may provide the measurement data after exposure of corresponding pre-layer of wafers 100 of the lot from the database 108 according to the ID or lot number of the lot, that is, the wafer history information 104 such as overlay measurement data of the DT layer and the GC layer. The system may also provide the measurement data after exposure of the M0 layer of several previous lots from a database (it may be another database) according to the ID or number of the exposure tool 102, that is, the exposure tool history information 106. The wafer history information 104 and the exposure tool history information 106 may be further transferred to the photolithographic parameter feedback system database 108 having a calculation mode established by previous fabrication. Subsequently, the wafer history information 104 and the exposure tool history information 108 are input to the database 108, and exposure parameters of the exposure tool 102 are thereby updated or adjusted. The M0 layer of wafers 100 of the lot is then exposed.

Accordingly, exposure parameters are determined by compensating not only offsets of the exposure tool or fabrication variation, but abnormal exposure results of pre-layer thereof. FIG. 3B shows the relationship among the overlay measurement residual 110 after exposure of the pre-layer, the baseline 112 of the current layer of the exposure tool, and the overlay measurement data 114 of the current layer; dotted line corresponds to a lot X. In FIG. 3B, see the time point (lot X), an extraordinary bump A appears in the overlay measurement residual 110 of the pre-layer. Before the current layer is exposed, exposure parameters of the tool may be modified referring to the overlay measurement residual 110 of the pre-layer. Therefore, the compensative value, bump B, is formed in the baseline 112 of the current layer in a direction opposite to bump A. Thus, the point C in the overlay measurement data 114 of the current layer may be well diminished with compensation. As a result, exposure offsets of the pre-layer are compensated to obtain high overlay quality.

The photolithographic parameter feedback system is illustrated in FIG. 3C and described in the following.

The exposure tool 118 may comprise a stepper or a scanner. Semiconductor wafers of a lot coated with photoresist are loaded into the exposure tool 118 by an automatic transmission system to expose a predetermined layer (or the current layer).

An alignment procedure is performed before exposure. The alignment mark on the mask serving as a coordinate aligns the subsequently exposed wafer to determine the compensative value of alignment offset vector thereon, further determining the best position of the wafers on the stage system to obtain the best corresponding position between the photoresist patterns on the current layer and the alignment mark on its pre-layer, and exposure is then performed.

A specific gas is stimulated by laser to produce photons of various wavelengths. Light having the specific wavelength such as KrF-248 nm (DUV) or ArF-193 nm is then obtained by a light filter and collected by a detector to form a required light source. The light source passes through the mask via dozens of lenses with repeated focus and scatter routes to finally project the mask patterns on the photoresist layer. The above description is the exposure manner of the exposure tool 118.

Next, the exposed wafers of the lot are transferred into a measuring tool such as an overlay measuring tool 200 using light with broad band to proceed the overlay measurement. Typically, the determination of an overlay specification between layers of individual product should consider of production or measuring tool errors, fabrication limitation, material characteristics (comprising resolvability of photoresist or photosensitive materials, precision of mask size, image bias on the resist due to light through lens, mask, and photoresist, mask bias, and etching bias), and proximity effect to achieve the best electrical performance of elements. Alignment accuracy of the exposure tool is the most important element for determining overlay quality excepting wafer or fabrication issues. The object of measurement is to obtain the best corresponding position between the photoresist patterns on the current layer and the alignment mark on its pre-layer to assure overlay quality of circuit patterns therebetween. In general, alignment between the current layer and the alignment mark on its pre-layer is performed by an alignment tree based on design rules. The overlay specification is established by the overlay mark coordinate of individual layer designed on the mask with a formulation in the overlay measuring tool 200 to monitor overlay quality therebetween.

Subsequently, overlay measurement data 300 is output by an automatic data transmission interface S100 such as a computer information manner (CIM).

Next, the overlay measurement data 300 is estimated with the overlay offset specification S200 by the overlay offset data control software of the photolithographic parameter feedback system. If the overlay measurement data 300 exceeds the overlay offset specification S200, the exposure fails. The data 300 is then cancelled, and the wafers of the lot are reworked in step S300. The exposure tool 118 and fabrication processes are also simultaneously checked.

If the overlay measurement data 300 is within the specification S200, overlay residual of the overlay measurement data 300 is then further estimated with overlay residual specification S400 by the overlay residual data control software of the photolithographic parameter feedback system. As a result, if the overlay residual is within the specification S400, the measurement data 300 then inputs a database 400. If the residual exceeds the threshold, the overlay measurement data 300 may still be acceptable, but it represents an abnormality and the abnormal lot is labeled in step S500. Finally, the overlay measurement data 300 and the abnormal label are input into the database 400.

If the exposure result passes the inspection, after the follow-up processes such as ion implantation, etching and so on, another exposure may be performed. For example, a lot X may enter the exposure tool 118 again and proceed with the M0 layer exposure, as shown in FIG. 3C, after the DT layer exposure, GC layer exposure, data collection, and etching or ion implantation. Exposure parameters are determined as follows.

First, the database 400 is surveyed. If the lot X has no abnormal label, its pre-layer exposure result such as DT layer or GC layer is normal. Therefore, only the horizontal photolithographic parameters feedback system mode S600 is operated with exposure tool history information corresponding to the current layer of several previous lots (comprising errors of the overlay measuring tool), and then the results are transmitted to the exposure tool 118 by the automatic data transmission interface S100 to compensate exposure parameters. The horizontal photolithographic parameter feedback system mode S600 considers overlay offsets from lot to lot. Put simply, the overlay measuring history information of several previous lots stored in the database is calculated with the photolithographic parameter feedback system calculation mode to produce compensative values. The compensative values then feedback to the corresponding parameters of the exposure tool. The method reduces the time spent using test wafers and reduces consumption of raw materials such as photoresist, hexamethyldisilazane (HMDS), developer or the like. A statistical average value is obtained from the overlay measurement data of the current layer of several previous lots such as three previous lots by the photolithographic parameter feedback system calculation mode to determine the best alignment exposure parameters of the current layer of the lot. The horizontal photolithographic parameters feedback system also provides the best exposure dose to control CD of the current layer.

If abnormal label appears in lot X in the database 400, even though the overlay measurement data after exposure of a pre-layer such as the DT layer or the GC layer may be within the specification, the residual thereof may be too large to accept. Therefore, it is necessary to operate a combined calculation mode S700, and then the results are transmitted to the exposure tool 118 by the automatic data transmission interface S100 to compensate the exposure parameters of the M0 layer. The combined calculation mode S700 comprises the horizontal and vertical photolithographic parameter feedback system calculation modes.

The vertical feedback calculation mode refers to the history information of the lot X, for example, if the reference baseline is the same as the M0 layer, overlay residual of its pre-layers such as the DT layer and the GC layer are collected to compensate the overlay measurement data (comprising an X-directional magnified exposure field overlay offset, a Y-directional magnified exposure field overlay offset, an X-directional exposure field rotation offset, a Y-directional exposure field rotation offset and so on). The following equation illustrates the vertical photolithographic parameter feedback system.

$${PPS}_{n}^{( v )} = {\sum }_{i = 1}^{N - 1} Ai ( α i ) \times α i \times ϖ i$$

PPSₙ^{(v)} is the output value of the vertical photolithographic parameter feedback system, Ai is a constant item, αi is the overlay residual of the i^{th} layer, \overline{ω}i is the weight of the αi in the equation. When |αi|<ki (Ki is the residual specification of the i layer), Ai=0, and when |αi|>ki, Ai=1. Simply, the overlay residual (αi) becomes significant if the |αi| exceeds a specific value (Ki). Additionally, the vertical photolithographic parameter feedback system may only consider the layers formed beyond the abnormal layer, because only the abnormal pre-layer may affect its post layer, thereby increasing data grab and calculation speed. For example, all the \overline{ω}i may be zero before abnormality occurs, and the \overline{ω}i may not be zero after abnormality occurs. If the abnormality appears in the DT layer of the lot X, both \overline{ω}_{DT} and \overline{ω}_{GC} are not zero. But, if the abnormality appears in the GC layer, the \overline{ω}_{DT} may be zero and \overline{ω}_{GC} does not.

The output value PPSₙ^{(H+v)} is the combination of the PPSₙ^{(H)} and the PPSₙ^{(v)}, by which the exposure parameters of the exposure tool are updated.

Ten overlay data comprise an X-directional offset, a Y-directional offset, a X-directional magnified wafer offset, a Y-directional magnified wafer offset, an X-directional wafer rotation offset, a Y-directional wafer rotation offset, an X-directional magnified exposure field offset, a Y-directional magnified exposure field offset, an X-directional exposure field rotation offset, and a Y-directional exposure field rotation offset. Either one of the above overlay data can or a combination thereof may be used as input data for the vertical and horizontal photolithographic parameter feedback systems.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A photolithographic parameter feedback system, comprising:
a database, comprising:
a substrate history information of a lot comprising at least one measurement data after exposure of a pre-layer of substrates of a predetermined lot; and
an exposure tool history information comprising at least one measurement data after exposure of a predetermined layer of substrates of a pre-lot; and
an exposure tool, exposing the substrates of the predetermined lot, wherein at least one exposure parameter of the exposure tool is updated by feedback of the substrate history information of the lot and the exposure tool history information.

2. The photolithographic parameter feedback system as claimed in claim 1, wherein the substrate comprises a wafer, a display substrate, an optical element substrate, a PCB, or other exposed materials.

3. The photolithographic parameter feedback system as claimed in claim 1, wherein the exposure tool is a stepper or a scanner.

4. The photolithographic parameter feedback system as claimed in claim 1, further comprising, a measuring tool used to produce the measurement data after exposure of the predetermined layer and the measurement data after exposure of the pre-layer.

5. The photolithographic parameter feedback system as claimed in claim 4, wherein the measuring tool comprises an overlay measuring tool used to measure overlay offset values after exposure between the predetermined layer and the pre-layer.

6. The photolithographic parameter feedback system as claimed in claim 4, wherein the measuring tool, further comprises, a critical dimension measuring tool used to measure a critical dimension of the predetermined layer after exposure.

7. A method for controlling photolithographic parameter, comprising:
providing a substrate history information of a lot comprising at least one overlay measurement data after exposure of a pre-layer of substrates of a predetermined lot;
providing an exposure tool history information of an exposure tool comprising at least one overlay measurement data after exposure of the predetermined layer of substrates of a pre-lot; and
controlling exposure parameters of the exposure tool by compensative values of the predetermined layer calculated by the substrate history information of the lot and the exposure tool history information with a calculation mode to expose the substrates of the predetermined lot.

8. The method as claimed in claim 7, wherein the substrate comprises a wafer, a display substrate, an optical element substrate, a PCB, or other exposed materials.

9. The method as claimed in claim 7, wherein the exposure parameters comprise substrate exposure alignment parameters.

10. The method as claimed in claim 7, wherein the exposure parameters further comprise exposure field alignment parameters.

11. The method as claimed in claim 7, wherein the overlay measurement data comprise at least an X-directional and a Y-directional overlay offset data.

12. The method as claimed in claim 7, wherein the exposure tool is a stepper or a scanner.

13. The method as claimed in claim 7, wherein the substrate history information of the lot comprises residual of the pre-layer of the substrates of the lot, and the residual refers to a random factor not completely compensated by a linear compensation.

14. The method as claimed in claim 7, wherein the calculation mode used to determine the compensative values for the predetermined layer according to the overlay measurement data corresponding to the substrate history information of the lot is based on an equation of
$${\sum }_{i = 1}^{N - 1} Ai ( α i ) \times α i \times ϖ i ,$$
wherein αi is the residual of the i^{th} layer, \overline{ω}i is the weight of the αi in the i^{th} layer, and Ai is a step function altered with αi, wherein when |αi|<k, Ai=0, and when |αi|>k, Ai=1.

15. The method as claimed in claim 7, wherein the exposure tool history information comprises overlay measurement data after exposure of substrates of a plurality of lots.

16. A method for controlling photolithographic parameter, comprising:
providing substrate history information of a lot comprising at least one measurement data after exposure of a pre-layer of substrates of the predetermined lot;
providing an exposure tool history information of an exposure tool comprising at least one measurement data after exposure of the predetermined layer of substrates of a pre-lot; and
updating at least one exposure parameter of the exposure tool by the substrate history information of the lot and the exposure tool history information to expose the substrates of the predetermined lot.

17. The method as claimed in claim 16, wherein the exposure parameters comprise substrate exposure alignment parameters and exposure field alignment parameters.

18. The method as claimed in claim 16, wherein the exposure parameters further comprise exposure dose parameters.

19. The method as claimed in claim 16, wherein the measurement data is overlay measurement data.

20. The method as claimed in claim 19, wherein the overlay measurement data comprise at least an X-directional and a Y-directional overlay offset data.

21. The method as claimed in claim 16, wherein the measurement data further comprise critical dimension measurement data.

22. The method as claimed in claim 16, wherein the exposure tool is a stepper or a scanner.

23. The method as claimed in claim 16, wherein the substrate history information of the lot comprises residual of the pre-layer of the substrates of the lot, and the residual refers to a random factor which cannot be completely compensated by a linear compensation.

24. The method as claimed in claim 16, wherein the calculation mode used to determine the compensative values for the predetermined layer according to the overlay measurement data corresponding to the substrate history information of the lot is based on an equation of
$${\sum }_{i = 1}^{N - 1} Ai ( α i ) \times α i \times ϖ i ,$$
wherein αi is the residual of the i^{th} layer, \overline{ω}i is the weight of the αi in the i^{th} layer, and Ai is a step function altered with αi, Wherein when |αi|<k, Ai=0, and when |αi|>k, Ai=1.

25. The method as claimed in claim 16, wherein the exposure tool history information comprises overlay measurement data after exposure of substrates of a plurality of lots.

26. The method as claimed in claim 16, wherein the measurement data is cancelled if the measurement data after exposure of the pre-layer is less than a specific value, during updating at least one exposure parameter of the exposure tool.

27. The method as claimed in claim 16, wherein the substrate comprises a wafer, a display substrate, an optical element substrate, a PCB, or other exposed materials.
